(19) United States
(12) Patent Application Publication
(10) Pub. No.: US 2020/0256701 A1
(43) Pub. Date: Aug. 13, 2020

(54) INFORMATION PROCESSING DEVICE, INFORMATION PROCESSING METHOD, AND NON-TRANSITORY STORAGE MEDIUM

(71) Applicants: TOYOTA JIDOSHA KABUSHIKI KAISHA, Toyota-shi (JP); Hitachi Solutions, Ltd., Tokyo (JP)

(72) Inventors: Akira IIJIMA, Nagoya-shi (JP); Yuichiro UEDA, Chiryu-shi, Aichi-ken (JP); Atsuko KOBAYASHI, Nagoya-shi (JP); Daisuke TANABE, Nisshin-shi (JP); Manabu YAMAMOTO, Toyota-shi (JP); Hiroyuki GOTO, Ichinomiya-shi (JP)

(73) Assignees: TOYOTA JIDOSHA KABUSHIKI KAISHA, Toyota-shi (JP); Hitachi Solutions, Ltd., Tokyo (JP)

(21) Appl. No.: 16/782,582

(22) Filed: Feb. 5, 2020

(30) Foreign Application Priority Data
Feb. 12, 2019 (JP) 2019-022691

(51) Int. Cl. G01C 21/36; H04R 1/02; H04R 3/00

(52) U.S. Cl. CPC G01C 21/3697; G01C 21/3667; G06Q 30/0265; H04R 1/025; H04R 3/00; G01C 21/3629

(57) ABSTRACT

An information processing device includes a control unit. The control unit is configured to output information on a facility a user is going to visit or a facility the user has visited, detect a visit to the facility indicated by the output information, and adjust the degree of output of the information on the facility based on the number of detected visits to the facility indicated by the output information.

### INCORPORATION BY REFERENCE

The disclosure of Japanese Patent Application No. 2019-022691 filed on Feb. 12, 2019 including the specification, drawings and abstract is incorporated herein by reference in its entirety.

### BACKGROUND

### 1. Technical Field

The disclosure relates to information processing devices, information processing methods, and non-transitory storage media.

### 2. Description of Related Art

In recent years, information communication technology for moving bodies such as vehicles have been increasingly advanced. In moving bodies, information such as advertisements is provided to occupants such as a driver. For example, Japanese Unexamined Patent Application Publication No. H9-97288 (JP 9-97288 A) discloses a product information providing device that can provide product information including cost information other than product prices in order to allow consumers to make appropriate purchase decisions.

### SUMMARY

Information processing devices are applied to moving bodies such as vehicles. In the case where the information processing devices provide information on a facility etc. which an occupant such as a driver, namely a user, is going to visit to the user, the information processing devices sometimes repeatedly provide the same information. This may bother the user and affect user's comfort. The disclosure restrains an information processing device configured to provide information on a facility etc. from repeatedly providing the same information to the user.

A first aspect of the disclosure relates to an information processing device. The information processing device includes a control unit. The control unit is configured to output information on a facility a user is going to visit or a facility the user has visited, is configured to detect a visit to the facility indicated by the information, and is configured to adjust a degree of output of the information on the facility based on the number of detected visits to the facility indicated by the information.

In the information processing device of the first aspect, the control unit may be configured to reduce the degree of output from a current degree of output when at least one of the number of the detected visits and a value corresponding to the number of the detected visits becomes larger than a predetermined reference value.

In the information processing device of the first aspect, a plurality of reference values may be set as the predetermined reference value.

In the information processing device of the first aspect, the control unit may be further configured to restrain, for a facility that is an exception to adjusting the degree of output out of the facilities, the adjustment of the degree of output which is made based on the number of the detected visits.

In the information processing device of the first aspect, the control unit may be configured to increase the degree of output of the information on the facility from the current degree of output when the information on the facility is updated.

In the information processing device of the first aspect, the control unit may be configured to increase the degree of output of the information on the facility from the current degree of output when a predetermined period has passed since the last output of the information on the facility.

In the information processing device of the first aspect, the degree of output may be a level of priority of outputting the information.

In the information processing device of the first aspect, the information processing device may be mounted on a vehicle, and the control unit may be configured to output the information on the facility the user is going to visit or the facility the user has visited by displaying information on a display mounted on the vehicle.

In the information processing device of the first aspect, the information processing device may be mounted on a vehicle, and the control unit may be configured to output the information on the facility the user is going to visit or the facility the user has visited by outputting audio from a speaker mounted on the vehicle.

In the information processing device of the first aspect, the information processing device may be mounted on a vehicle, and the control unit may be configured to detect a visit to the facility indicated by the information based on location information of the vehicle.

A second aspect of the disclosure relates to an information processing method configured to be performed by at least one computer. The information processing method includes: outputting information on a facility a user is going to visit or a facility the user has visited; detecting a visit to the facility indicated by the information; and adjusting a degree of output of the information on the facility based on the number of detected visits to the facility indicated by the information.

In the information processing method of the second aspect, the at least one computer may be configured to reduce the degree of output from a current degree of output when at least one of the number of the detected visits and a value corresponding to the number of the detected visits becomes larger than a predetermined reference value.

In the information processing method of the second aspect, a plurality of reference values may be set as the predetermined reference value.

The information processing method of the second aspect may further include restraining, for a facility that is an exception to adjusting the degree of output out of the facilities, the adjustment of the degree of output which is made based on the number of the detected visits.

In the information processing method of the second aspect, the at least one computer may be configured to increase the degree of output of the information on the facility from the current degree of output when the information on the facility is updated.

In the information processing method of the second aspect, the at least one computer may be configured to increase the degree of output of the information on the facility from the current degree of output when a predetermined period has passed since the last output of the information on the facility.

A third aspect of the disclosure relates to a non-transitory storage medium storing an instruction that is executable by one or more processors. The instruction stored in the non-transitory storage medium causes the one or more processors to carry out functions. The functions include: outputting information on a facility a user is going to visit or a facility the user has visited; detecting a visit to the facility indicated by the information; and adjusting a degree of output of the information on the facility based on the number of detected visits to the facility indicated by the information.

According to the first, second, and third aspects of the disclosure, the same information is restrained from being repeatedly provided to the user.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a hardware configuration diagram of an information processing device of an embodiment;

FIG. 2 illustrates an application example of a vehicle, which is a moving body, having the information processing device of FIG. 1 mounted thereon;

FIG. 3 shows the configuration of a detection count database;

FIG. 4 shows the configuration of an output degree database;

FIG. 5 is a flowchart illustrating how the information processing device of FIG. 1 outputs information on a facility; and

FIG. 6 is a flowchart illustrating how the information processing device of FIG. 1 adjusts the degree of output of information on a facility.

### DETAILED DESCRIPTION OF EMBODIMENTS

An information processing device according to an embodiment will be described with reference to the accompanying drawings. The configuration of the following embodiment is illustrative, and the information processing device is not limited to the configuration of the embodiment. The present embodiment is described with respect to an information processing device applied to a vehicle, which is a moving body, and configured to provide to an occupant of the vehicle information on a facility he or she is going to visit or a facility he or she has visited, such as an advertisement. The information processing device is, e.g., an information processing device that is mounted on a moving body an occupant boards. Examples of the moving body other than a vehicle include a watercraft and an aircraft. The occupant can also be referred to as the user of the moving body and is the user of the information processing device. The occupant may be either a driver or a passenger who does not drive. The information processing device may be a device that is carried by the user such as a terminal that can be carried around by the user.

The information processing device has a control unit. The control unit performs a first process and a second process. The first process includes outputting information on a facility a user is going to visit or a facility the user has visited, such as an advertisement, and detecting a visit to the facility indicated by the output information.

The information on the facility such as an advertisement includes not only information presented by the facility such as distributed information called an electronic flyer or a digital flyer which is viewed on digital media, but also information provided by an agency that collects or edits information on facilities, etc. When the information on the facility such as an advertisement is an advertisement, the information on the facility may contain information on the prices, qualities, and places of origin of products and services provided by the facility. The visit to the facility indicated by the information may include a direct visit to the facility and may also include, e.g., reaching a predetermined area located around the facility.

Outputting the information includes displaying information on a display unit such as a display and presenting information by sound such as audio from an audio output device such as a speaker. The information may be output by combination of display of information on the display unit and presentation of information by sound.

Detecting a visit to the facility may include directly detecting a direct visit to the facility based on outputs of various sensors. For example, detecting a visit to the facility includes presuming that the user has reached a predetermined area located around the facility based on location information of the moving body or the user. Detecting a visit to the facility further includes preferably storing, and more preferably storing in an updatable manner, the detection result, especially the number of detected visits, in association with the facility indicated by the information.

The second process includes adjusting the degree of output of the information on the facility, which is the degree to which the information on the facility is output, based on the number of detected visits to the facility indicated by the output information. The degree of output means the degree to which the information on the facility is output to the user and can also be referred to as the level of priority of providing information. For example, the second process includes adjusting the degree of output of the information on the facility when the number of detected visits satisfies a predetermined condition (hereinafter referred to as the first predetermined condition). For example, the number of detected visits satisfying the first predetermined condition includes the number of detected visits being larger than a predetermined reference value. The predetermined reference value may be either a fixed value or a variable. For example, the predetermined reference value may be varied according to the moving object or the user. The predetermined reference value may include a plurality of reference values. In the present specification, the number of detected visits may not be the number of detected visits itself but may be a value corresponding to the number of detected visits such as the frequency of visit corresponding to the number of detected visits to the facility. The second process may include adjusting the degree of output of the information on the facility when both the number of detected visits and the value corresponding to the number of detected visits satisfy the first predetermined condition.

Adjusting the degree of output of the information on the facility in the second process may include adjusting the frequency at which the information is output and adjusting the form in which the output information is displayed. For example, when the position where the output information is displayed can be adjusted between a noticeable position and an unnoticeable position, adjusting the degree of output of the information on the facility in the second process may be adjusting whether the output information is displayed on the noticeable position or the unnoticeable position.

In the second process, the degree of output of the information on the facility need not necessarily be adjusted when the number of detected visits to the facility satisfies the first predetermined condition. For example, the degree of output of the information on the facility may further be adjusted when the information on the facility is updated or when a predetermined period has passed since the last output of the information on the facility. At this time, for example, the degree of output of the information on the facility may be increased from the current degree of output. For a facility that is an exception to adjusting the degree of output out of the facilities, adjustment of the degree of output which is made based on the number of detected visits may be restrained.

### Configuration

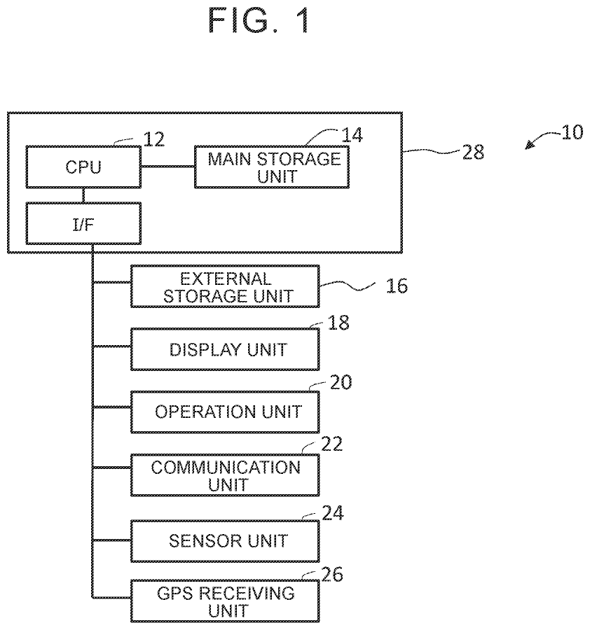

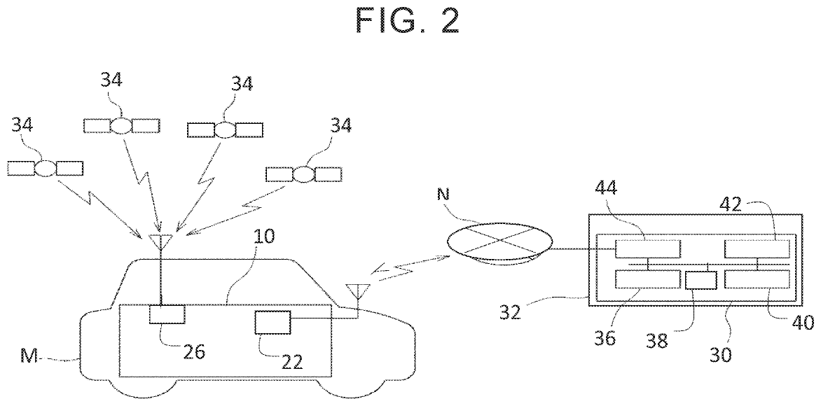

FIG. 1 is a hardware configuration diagram of an information processing device 10 according to the present embodiment. FIG. 2 illustrates an application example of a vehicle M, which is a moving body, having the information processing device 10 mounted thereon.

The information processing device 10 includes a CPU 12, a main storage unit 14, and external devices connected through an interface (I/F) and performs information processing according to a program. The CPU 12 is also called a processor. The CPU 12 is not limited to a single processor. The CPU 12 may be a plurality of processors that cooperatively perform processing or may be a multi-core processor having a plurality of arithmetic processing units. The CPU 12 may include, in addition to a general-purpose processor, a dedicated processor, a dedicated digital circuit, etc. which perform image processing, signal processing, machine learning processing, multiply-accumulate operations, vector operations, etc. at high speed or in parallel. The main storage unit 14 is an example of a main storage device. Examples of the external devices include an external storage unit 16, a display unit 18, an operation unit 20, a communication unit 22, a sensor unit 24, and a Global Positioning System (GPS) receiving unit 26.

The CPU 12 executes a computer program loaded in the main storage unit 14 such that the computer program can be executed and provides the functions of the information processing device 10. The main storage unit 14 stores the computer program to be executed by the CPU 12, data to be processed by the CPU 12, etc. The main storage unit 14 is a dynamic random access memory (DRAM), a static random access memory (SRAM), a read only memory (ROM), etc. The CPU 12 and the main storage unit 14 can together be called a control unit 28. The control unit 28 controls the information processing device 10 according to the computer program and performs an information processing method of the present embodiment.

The external storage unit 16 is used, e.g., as a storage area that assists the main storage unit 14. The external storage unit 16 stores the computer program to be executed by the CPU 12, the data to be processed by the CPU 12, etc. The external storage unit 16 is a hard disk drive, a solid-state drive (SSD), etc. The information processing device 10 may be provided with a drive device for a removable storage medium. Examples of the removable storage medium include a Blu-ray disc, a digital versatile disc (DVD), a compact disc (CD), and a flash memory card.

Examples of the display unit 18 include a liquid crystal display and an electroluminescence panel. The operation unit 20 may be, e.g., a keyboard, a pointing device, etc. More specifically, in the present embodiment, the operation unit 20 includes a touch panel.

The communication unit 22 communicates via, e.g., a mobile phone base station and a public communication network connected to the mobile phone base station, namely a network N (see FIG. 2), with other device(s) on the network N such as a server 30 that provides services to a moving body or a user, and transmits and receives data to and from the other device(s) on the network N.

The sensor unit 24 may be, e.g., a seat pressure sensor mounted in a seat of the vehicle M, a camera, etc. The sensor unit 24 can thus detect that there is an occupant in the vehicle M. Especially in the present embodiment, the sensor unit 24 includes a seat pressure sensor in order to identify an occupant, namely a user. The sensor unit 24 may further include other biosensor. Alternatively, the sensor unit 24 may not include the seat pressure sensor and may include a biosensor.

As shown in FIG. 2, the GPS receiving unit 26 receives radio waves of time signals, that is, positioning signals, from a plurality of artificial satellites (global positioning satellites) 34 orbiting the Earth. The control unit 28 obtains location information of the vehicle M based on the signals received by the GPS receiving unit 26. The location information may be detected based on a signal from a satellite navigation system other than the GPS.

As described above, the information processing device 10 having the above configuration can communicate with the server 30 to transmit and receive data to and from the server 30. Various computers may be provided instead of the server 30.

The server 30 is located in an information processing center 32 and includes a control unit 36 and external devices connected through an interface (I/F). The server 30 includes as the external devices an external storage unit 38, a display unit 40, an operation unit 42, and a communication unit 44. Like the control unit 28, the control unit 36 includes a processor and a main storage device. The external storage unit 38 has a configuration similar to that of the external storage unit 38. The display unit 40 may be configured similarly to the display unit 18, and the operation unit 42 may be configured similarly to the operation unit 20. The operation unit 42 is, e.g., a keyboard. The communication unit 44 has a configuration similar to that of the communication unit 22 and can communicate via the network N with other device(s) on the network N such as the information processing device 10.

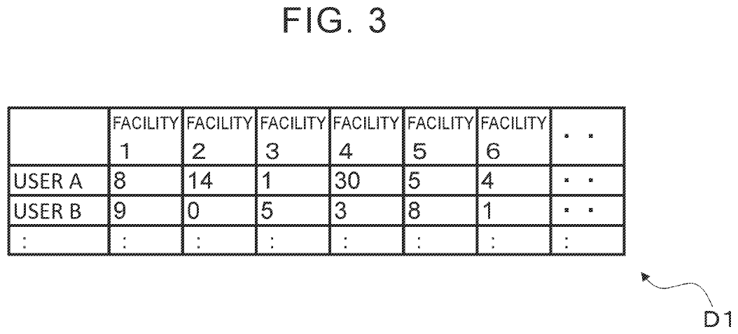

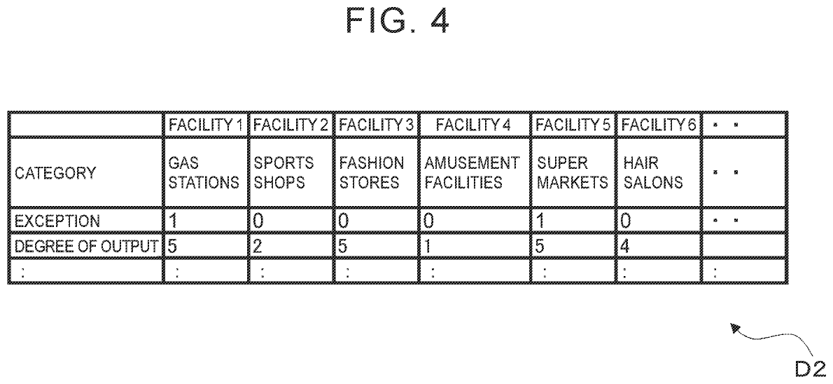

FIG. 3 shows the configuration of a detection count database D1 of the number of detected visits to each facility indicated by information such as an advertisement. FIG. 4 shows the configuration of an output degree database D2 defining, for each facility, the degree of output of information such as an advertisement according to the number of detected visits. In the present embodiment, the databases of FIGS. 3 and 4 are stored in the information processing device 10. However, these databases may be stored in either the information processing device 10 or the server 30 or may be stored in other computers. In the present embodiment, the output degree database of FIG. 4 is created for each user.

The columns in the detection count database D1 of FIG. 3 indicates the number of times each user has visited each facility, namely Facilities 1 to 6 in FIG. 3. That is, the columns in the detection count database D1 of FIG. 3 indicate the number of detected visits to each facility by each user. As shown in the output degree database D2 of FIG. 4, each of Facilities 1 to 6 is put into one of a plurality of categories. Specifically, the plurality of categories are gas stations, sports shops, fashion stores, amusement facilities, supermarkets, and hair salons. However, facilities according to the technique of the present disclosure are not limited to the categories shown in FIG. 4. Other categories can be, e.g., facilities such as gyms, bookstores, restaurants (e.g., Western food restaurants, Chinese restaurants, and Japanese restaurants), and hospitals. As described later, in the present embodiment, these facility categories are used to adjust the degree of output of information such as an advertisement. However, for example, facilities may be put into only two categories, namely a category for which the degree of output of information is adjusted and a category for which the degree of output of information is not adjusted. Such categorization may be performed by the control unit 28 or the control unit 36 based on a categorization database that is available. Alternatively, a user, namely an occupant of the vehicle M, may perform a categorization operation via the operation unit 20.

In the detection count database D1 of FIG. 3, each row is associated with a corresponding user. Two users, USER A and USER B, are shown in the detection count database D1 of FIG. 3. In the present embodiment, there are a plurality of users who drives the vehicle M, and two of the plurality of users (drivers) are USER A and USER B. The information processing device 10 determines the user based on user information that is input through the touch panel of the operation unit 20. For example, the user information may be input through the touch panel in response to the control unit 28 causing the display unit 18 to ask who the user is when the user gets into the driver's seat and starts a driving source such as an engine. However, the information processing device 10 may determine the user by other methods or means. In the present embodiment, as described above, the sensor unit 24 includes a seat pressure sensor. Accordingly, the control unit 28 of the information processing device 10 may detect the weight of the driver of the vehicle M based on the output of the sensor, and when there is a record of a user whose weight corresponds to the detected weight, the control unit 28 may ask whether the driver is the estimated user. The information processing device 10 may not identify individual drivers but accumulate information of all the drivers who have been seated in the driver's seat of the vehicle M to process them as a user. This is because it is assumed that each vehicle is often driven by a single owner.

In the present embodiment, when the vehicle M or the user is located in a predetermined area centered on the location indicated by location information of each facility, the control unit 28 detects a visit to the facility by the vehicle M or the user by the following procedure. When the control unit 28 detects that the vehicle M or the user is located in the predetermined area based on the location information obtained via the GPS receiving unit 19, and the driving source of the vehicle M is turned off or the user leaves the vehicle M, the control unit 28 detects a visit to the facility by the vehicle M or the user. For example, when the driving source of the vehicle M such as an engine or a driving motor is turned off while the vehicle M or the user is located in a predetermined area around a facility, the control unit 28 detects a visit to the facility by the user. For example, when the sensor unit 24 is a seat pressure sensor, whether the user has left the vehicle M may be determined based on the output from the sensor. The control unit 28 need not necessarily detect a visit to a facility by the method or means described herein. For example, the control unit 28 may detect a visit to a facility by merely detecting that a moving body or a user is located in a predetermined area centered on the location indicated by location information of each facility. In the case where a map is displayed on the display unit 18, the control unit 28 can perform such detection when the vehicle M or the user on the map enters the predetermined area.

The number of detected visits to each facility is cumulatively stored in the detection count database D1 illustrated in FIG. 3. The detection count database D1 may be stored in an updatable manner and may be backed up to the server 30, e.g., regularly or at a predetermined timing by communication between the server 30 and the information processing device 10. The number of detected visits to each facility may be the number of detected visits within a predetermined period. For example, the detection count database D1 may be updated with the number of detected visits within the past year. In the present embodiment, the detection count database D1 shows the number of detected visits by each user within the past two months. That is, the number of detected visits to each facility in the detection count database D1 is based on the data of the “facility” and the “date and time of each detected visit” to the facility which are stored in association with each other. For example, the number of detected visits to Facility 2 by USER A, which is “14,” is based on the data of “Facility 2” and the “date and time of each detection” of a visit to Facility 2 which are stored in association with each other.

The control unit 28 outputs information on a facility the user is going to visit or a facility the user has visited to the display unit 18. For example, the facility the user is going to visit may be a destination facility input by the driver to the operation unit 20 that is also, e.g., a car navigation screen of the vehicle M, or may be a destination facility estimated from the driving history of the vehicle M that is a moving body. The facility the user has visited may be any facility located on a route to the facility the user is going to visit or any facility located around these facilities. In the present embodiment, when such a target facility is set or estimated, various facilities the user has visited, which are located between the current location and the target facility, are also set as facilities the user has visited. The control unit 28 obtains information on these facilities by communication with the server 30 and displays the obtained information such as advertisements on the display unit 18.

At this time, the control unit 28 adjusts the degree of output of information based on the visit history to these facilities, that is, the number of times a visit to each facility was detected (the number of detected visits). For example, when the control unit 28 outputs information about a facility and detects a visit to the facility, the control unit 28 reduces the degree of output of the information from the current degree of output based on the number of detected visits. Especially in the present embodiment, when the number of detected visits has increased, the degree of output of information on the facility relating to the number of detected visits is reduced from the current degree of output. More specifically, when the number of detected visits to the facility becomes larger than a predetermined reference value, the degree of output of the information on the facility is reduced from the current degree of output. That is, the larger the number of detected visits to the facility is or the higher the frequency of visit is, the higher the tendency not to provide the information on the facility is. The frequency of visit is a value corresponding to the number of detected visits to the facility.

The output degree database D2 for USER A in FIG. 4 shows whether each facility is an exception to adjusting the degree of output. This “exception” is set to determine whether each facility is a facility for which the degree of output of information is adjusted. In general, users frequently go to grocery stores and supermarkets in order to engage in human social activities and frequently go to gas stations to refuel the vehicle M. It is not suitable to reduce the degrees of output of information on such facilities based on the numbers of detected visits. Accordingly, “exception” is set for the facilities in these categories. Regarding “exception” in the output degree database D2 of FIG. 4, “1” means that output of information on the facility is not affected by the number of detected visits, and “0” means that output of information on the facility is adjusted according to the number of detected visits.

In FIG. 4, for Facilities 1 and 5 with their “exception” being “1,” the degree of output is “5” that is a degree of output in an initial state, namely a normal degree of output. For those facilities with their “exception” being “0,” the degree of output is variable among “5,” “4,” “3,” “2,” and “1.” The information processing device 10 stores reference values for adjusting the degree of output. For example, values such as “3,” “5,” “10,” and “20,” which are the numbers of visits within the past two months, are set as the reference values in the information processing device 10. The first reference value “3” means that the degree of output is reduced from the high degree of output “5” to “4” when the number of detected visits becomes equal to or larger than 3. For Facility 3, the number of detected visits in FIG. 3 is 1. The degree of output is therefore kept at the high degree of output “5.” For Facility 6, the number of detected visits in FIG. 3 is 4, which is equal to or larger than the first reference value “3” but is smaller than the second reference value “5.” As shown in FIG. 4, the degree of output is therefore adjusted to “4” that is lower than “5” by one. For Facility 5, the number of detected visits in FIG. 3 is 5, which is equal to or larger than the second reference value “5.” The degree of output is therefore supposed to be adjusted to “3” that is lower than “4.” However, since “exception” for Facility 5 is “1,” the degree of output is kept at “5” as described above. For Facility 2, the number of detected visits in FIG. 3 is 14, which is equal to or larger than the third reference value “10” but is smaller than the fourth reference value “20.” As shown in FIG. 4, the degree of output is therefore adjusted to “2” that is lower than “5” by three. For Facility 4, the number of detected visits in FIG. 3 is 30, which is equal to or larger than the fourth reference value “20.” As shown in FIG. 4, the degree of output is therefore adjusted to the lowest degree of output “1.” This lowest degree of output is the level at which information on a corresponding facility will not be output.

Note that the first to fourth reference values are initial values, and in the present embodiment, are variable. Comparison between USER A and USER B in the detection count database D1 of FIG. 3 shows that the overall number of detected visits to each facility by USER B is smaller than that by USER A. Accordingly, there is a limit to applying the first to fourth reference values to USER B in the same manner as they are applied to USER A. The reference values are varied in view of the overall number of visits by each user. A map for varying the reference values may be prepared. As described above, in the present embodiment, the output degree database is provided for each user. The database in FIG. 4 is the database for USER A and is independent of the database for USER B. However, the database for USER A and the database for USER B may be integrated.

### Process Flow

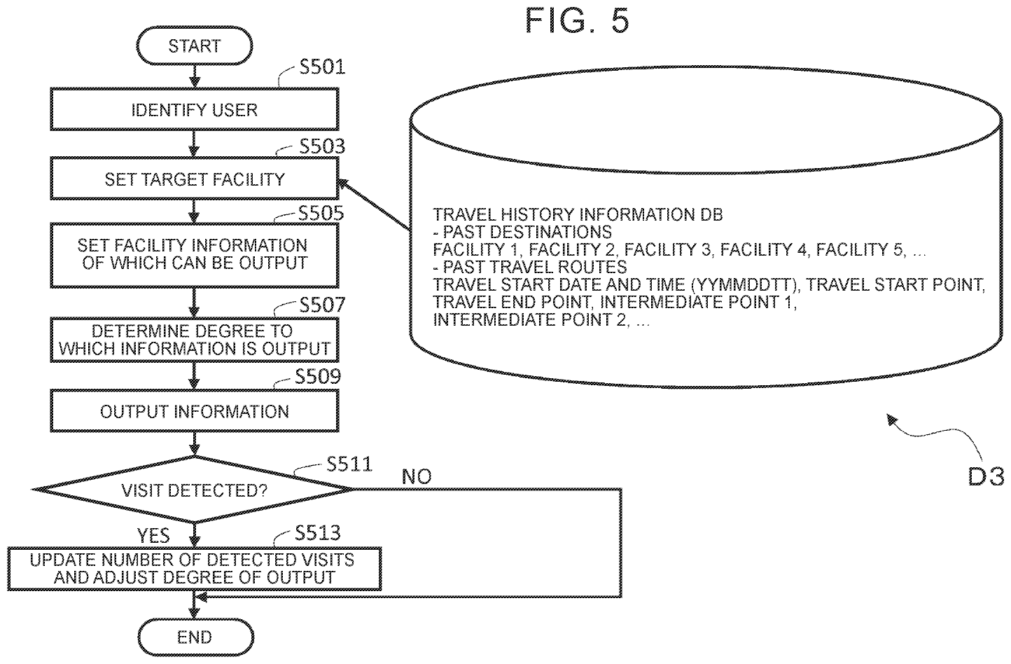

First, how the information processing device 10 of the present embodiment outputs information on facilities will be described with reference to the flowchart of FIG. 5.

When the driver gets into the vehicle M and the driving source is started, the control unit 28 first identifies the user (step S501). As described above, the control unit 28 can identify the user according to input from the operation unit 20. It is herein assumed that the driver is identified as USER A. Step S501 may be omitted in the case where the information processing device 10 processes all the drivers who have been seated in the driver's seat as a user.

Next, the control unit 28 sets a facility the user is going to visit, namely a target facility (step S503). As described above, in the case where the driver etc. inputs a facility through the operation unit 20, the target facility is the facility input by the driver etc. Otherwise, the target facility is estimated and set by the control unit 28. In this example, the control unit 28 can set the target facility based on the past destination(s), the travel start date(s) and time(s), the travel start point(s), weather, etc. described in a travel history information database D3 for the driver. For example, it is assumed that the travel history shows that USER A, who is the driver, often gets into the vehicle M at around 20:00 and drives from home to Facility 4. In this case, the larger the extent to which the conditions for setting the target facility match the conditions in the travel history, the more likely the control unit 28 is to set Facility 4 as the target facility. At this time, a prompt asking whether Facility 4 can be set as the target facility may be output by display on the display unit 18 etc. in order to obtain the driver's approval. The travel history information database D3 may be stored in the information processing device 10 of the vehicle M or may be stored in other computer such as the server 30.

Then, the control unit 28 first derives a route from the current location to the target facility and sets any facility which the driver has visited and is located on the route or within a predetermined distance from the route, namely any facility, other than the target facility, information of which can be output (step S505). The route can be derived by a conventional car navigation technique in view of the distance from the current location to the target facility, the road width, the presence or absence of toll roads, etc. The control unit 28 then sets a facility (facilities) other than the target facility as a facility (facilities) information of which is to be output, based on the information in the databases D1, D2 of FIGS. 3 and 4 and the travel history information database D3 of FIG. 5 and information obtained via the network N. For example, the target facility is Facility 2, and Facilities 4, 5 are set as the facilities which the driver has visited and are located on the route.

The control unit 28 then reads information on the degrees of output of information on these facilities from the output degree database D2 in FIG. 4 and determines the degree to which information is output, based on these degrees of output of information (step S507). For example, when the destination is Facility 2 and Facilities 4, 5 are located on the route to Facility 2, the control unit 28 determines that the degree of output of information on Facility 5 (value “5”) is the highest, the degree of output of information on Facility 2 (value “2”) is the second highest, and the degree of output of information on Facility 4 (value “1”) is the lowest.

The control unit 28 then obtains information on each facility from the server 30 etc. and outputs the information on each facility according to the determined degree of output (step S509). The information on Facility 5 will be output at a frequency corresponding to the degree of output “5,” the information on Facility 2 will be output at a frequency corresponding to the degree of output “2,” and the information on Facility 4 will not be output.

When it is detected that the vehicle M or the user has arrived at the target facility or other facility information of which has been output (YES in step S511), the control unit 28 updates the number of detected visits to the detected facility in the detection count database D1 in FIG. 3 (step S513). Specifically, the control unit 28 increments the number of detected visits stored in the detection count database D1 of FIG. 3 by “1.” The control unit 28 thus adjusts the degree of output of information on the facility in the output degree database D2 of FIG. 4 according to the resultant number of detected visits. The control unit 28 may reduce the degree of output from the current degree of output when the number of detected visits or a value corresponding to the number of detected visits becomes larger than a predetermined reference value. The predetermined reference value may be a plurality of reference values, and the control unit 28 may adjust the degree of output of information according to the plurality of reference values.

When it is not detected that the vehicle M or the user has arrived at the target facility or other facility information of which has been output (NO in step S511), there is no relationship between the output of information and the location such as a facility the vehicle M or the user has arrived. This is therefore not reflected on the detection count database D1. The routine is thus terminated.

As described above, the degree of output of information on each facility is adjusted based on the number of detected visits to the facility. Information on each facility information of which is to be provided is output as appropriate according to the adjusted degree of output of information. Especially, the larger the number of detected visits to the facility is, the lower the degree of output of information on this facility is, and thus the more the information is restrained from being output. The information processing device 10 configured to provide information on facilities is thus restrained from repeatedly providing the same information.

The degree of output of information on each facility is adjusted based on the number of detected visits to the facility. However, the number of detected visits that affects the adjustment of the degree of output of information need not necessarily be a plurality of detected visits. For example, the degree of output of information may be adjusted to zero even when the number of detected visits is one.

Next, how the information processing device 10 of the present embodiment adjusts, especially increases, the degree of output of information on each facility will be described.

First, the detection count database D1 of FIG. 3 will be further described. As described above, the detection count database D1 of FIG. 3 indicates the numbers of detected visits in the past two months. For example, it is herein assumed that the user frequently visited a specific facility six months ago and the degree of output of information on this specific facility has therefore been reduced. Even in this case, the control unit 28 adjusts the degree of output of information on this specific facility in the output degree database D2 of FIG. 4 to the highest degree of output “5,” when, for example, the number of detected visits within the past two months is zero. The control unit 28 can thus increase the degree of output of information on that facility from the current degree of output when a predetermined time has passed since the last output of the information on that facility.

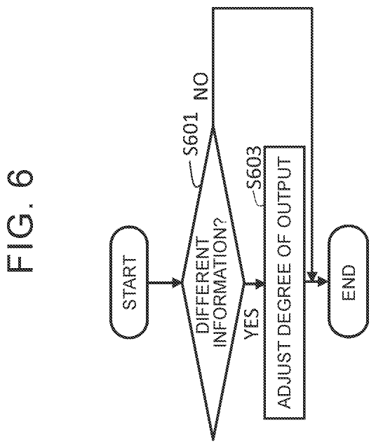

How the control unit 28 increases the degree of output of information will be described with reference to FIG. 6. When the control unit 28 obtains information in step S509, it determines whether the obtained information is different from the information obtained in the past (step S601). The control unit 28 makes this determination by comparing the past information on the facility stored in the server 30 etc. with the newly obtained information. The control unit 28 may make this comparison based on the date and time the obtained information was created etc. rather than by comparing the information itself

When the obtained information is not new (NO in step S601), the routine is terminated. When the obtained information is new (YES in step S601), the control unit 28 increases the degree of output of information on the facility (step S603). In this example, the degree of output of information is increased by one. For example, when the current degree of output of information is “3,” the degree of output of information is adjusted to “4.” The new information on the facility can thus be suitably provided to the user.

The degree of output of information on the facility is preferably increased according to the user's needs. For example, the degree of output may be increased for information that matches the tendency of the user's needs estimated from his or her social networking service (SNS) or the user's needs input through the operation unit 20 etc. For example, when the category of the user's needs is sports or baseball, the degree of output of information on Facility 2 having commonality with the category may be actively increased. Specifically, not only whether the information is new but also whether the information matches the user's needs may be determined in step S601.

The above embodiment is described by way of illustration, and modifications can be made as appropriate without departing from the scope of the disclosure. The processes and means described in the present disclosure can be combined as desired as long as no technical contradictions occurs.

The processing described as being performed by a single device may be performed by a plurality of devices. For example, the information processing device 10 need not necessarily be a single computer but may be configured as a system including a plurality of computers. Alternatively, the processing described as being performed by different devices may be performed by a single device. The hardware configuration (server configuration) that implements each function in a computer system can be flexibly changed.

The disclosure can also be implemented by providing a computer program having the functions described in the above embodiments to a computer and reading and executing the program by one or more processors included in the computer. Such a computer program may be provided to the computer by a non-transitory computer-readable storage medium that can be connected to a system bus of the computer or may be provided to the computer via a network. Examples of the non-transitory computer-readable storage medium include any types of disks or discs such as magnetic disks (floppy (registered trademark) disks, hard disk drives (HDDs), etc.) and optical disks (CD-ROMs, DVD discs, Blu-ray discs, etc.), read-only memories (ROMs), random access memories (RAMs), erasable programmable read-only memories (EPROMs), electrically erasable programmable read-only memories (EEPROMs), magnetic cards, flash memories, optical cards, and any types of media suitable for storing electronic instructions.

What is claimed is:

1. An information processing device, comprising:
a control unit configured to
output information on a facility a user is going to visit or a facility the user has visited,
detect a visit to the facility indicated by the information, and
adjust a degree of output of the information on the facility based on the number of detected visits to the facility indicated by the information.

2. The information processing device according to claim 1, wherein the control unit is configured to reduce the degree of output from a current degree of output when at least one of the number of the detected visits and a value corresponding to the number of the detected visits becomes larger than a predetermined reference value.

3. The information processing device according to claim 2, wherein a plurality of reference values are set as the predetermined reference value.

4. The information processing device according to claim 1, wherein the control unit is further configured to restrain, for a facility that is an exception to adjusting the degree of output out of the facilities, the adjustment of the degree of output which is made based on the number of the detected visits.

5. The information processing device according to claim 1, wherein the control unit is configured to increase the degree of output of the information on the facility from a current degree of output when the information on the facility is updated.

6. The information processing device according to claim 1, wherein the control unit is configured to increase the degree of output of the information on the facility from a current degree of output when a predetermined period has passed since the last output of the information on the facility.

7. The information processing device according to claim 1, wherein the degree of output is a level of priority of outputting the information.

8. The information processing device according to claim 1, wherein:
the information processing device is mounted on a vehicle; and
the control unit is configured to output the information on the facility the user is going to visit or the facility the user has visited by displaying information on a display mounted on the vehicle.

9. The information processing device according to claim 1, wherein:
the information processing device is mounted on a vehicle; and
the control unit is configured to output the information on the facility the user is going to visit or the facility the user has visited by outputting audio from a speaker mounted on the vehicle.

10. The information processing device according to claim 1, wherein:
the information processing device is mounted on a vehicle; and
the control unit is configured to detect a visit to the facility indicated by the information based on location information of the vehicle.

11. An information processing method configured to be performed by at least one computer, the information processing method comprising:
outputting information on a facility a user is going to visit or a facility the user has visited;
detecting a visit to the facility indicated by the information; and
adjusting a degree of output of the information on the facility based on the number of detected visits to the facility indicated by the information.

12. The information processing method according to claim 11, wherein the at least one computer is configured to reduce the degree of output from a current degree of output when at least one of the number of the detected visits and a value corresponding to the number of the detected visits becomes larger than a predetermined reference value.

13. The information processing method according to claim 12, wherein a plurality of reference values are set as the predetermined reference value.

14. The information processing method according to claim 11, further comprising restraining, for a facility that is an exception to adjusting the degree of output out of the facilities, the adjustment of the degree of output which is made based on the number of the detected visits.

15. The information processing method according to claim 11, wherein the at least one computer is configured to increase the degree of output of the information on the facility from a current degree of output when the information on the facility is updated.

16. The information processing method according to claim 11, wherein the at least one computer is configured to increase the degree of output of the information on the facility from a current degree of output when a predetermined period has passed since the last output of the information on the facility.

17. A non-transitory storage medium storing an instruction that is executable by one or more processors, the instruction causing the one or more processors to carry out functions, the functions comprising:
outputting information on a facility a user is going to visit or a facility the user has visited;
detecting a visit to the facility indicated by the information; and
adjusting a degree of output of the information on the facility based on the number of detected visits to the facility indicated by the information.
